(19) United States
(12) Patent Application Publication
(10) Pub. No.: US 2026/0322606 A1
(43) Pub. Date: Oct. 15, 2026

(54) PASSWORD-LESS AUTHENTICATION

(71) Applicant: Penguin Computing, Inc., Newark, CA (US)

(72) Inventor: Thomas Ruge, Denver, CO (US)

(21) Appl. No.: 19/567,559

(22) Filed: Mar. 16, 2026

Related U.S. Application Data
(60) Provisional application No. 63/786,694, filed on Apr. 10, 2025.

(51) Int. Cl. H04L 9/32

(52) U.S. Cl. CPC H04L 9/321

(57) ABSTRACT

Various embodiments for implementing a remote computing system with password-less authentication are provided. A computing device such as a laptop or other client device can establish a secure connection with a remote server via an untrusted network without exchanging credentials. The computing device can begin by establishing an initial secure session with an authentication server (e.g., a corporate authentication server) and once authenticated by the authentication server, the authentication server can transfer a cryptographic key (e.g., a private key) to the computing device. Using the cryptographic key, the computing device can establish a secure session with the remote server, which already has another cryptographic key (e.g., a public key) installed thereon.

### RELATED APPLICATIONS

This application is a non-provisional application claiming the benefit of priority to U.S. Provisional Patent Application Ser. No. 63/786,694, filed Apr. 10, 2025, the disclosure of which is hereby incorporated herein by reference in its entirety.

### FIELD OF THE DISCLOSURE

The present disclosure relates to password-less authentication of a remote server in a remote computing environment.

### BACKGROUND

Remote desktop technologies have become integral to modern computing, enabling users to access and control computing systems from virtually any location. This flexibility has made remote desktop environments essential for IT administration, telecommuting, technical support, and a variety of enterprise applications. Typically, access to these environments is gated through password-based authentication mechanisms, which verify a user's identity before granting access to the remote system.

However, reliance on traditional password authentication introduces several security risks, particularly in remote desktop contexts. Passwords can be intercepted during transmission, especially in cases where encryption is weak or misconfigured. These vulnerabilities are further amplified in remote desktop settings, where unauthorized access can provide direct control over sensitive systems and data. Despite the widespread adoption of secure tunneling protocols and multi-factor authentication (MFA), the foundational weakness of passwords continues to pose a substantial threat to the integrity of remote access environments. Accordingly, there is a need for more secure, resilient, and user-friendly methods of authenticating access to remote desktops.

### SUMMARY

Various embodiments for implementing a remote computing system with password-less authentication are provided. A computing device such as a laptop or other client devices can establish a secure connection with a remote server via an untrusted network without exchanging credentials. The computing device can begin by establishing an initial secure session with an authentication server (e.g., a corporate authentication server), and once authenticated by the authentication server, the authentication server can transfer a cryptographic key (e.g., a private key) to the computing device. Using the cryptographic key, the computing device can establish a secure session with the remote server, which already has another cryptographic key (e.g., a public key) installed thereon.

In an embodiment, a computing device is provided that includes a processor, and computer executable instructions that when executed by the processor cause the computing device to perform operations. The operations include authenticating the computing device with an authentication server, and receiving, via the authentication server, a private key. The operations also include establishing a second secure session with a remote server, wherein the second secure session is established based on a public key at the remote server, and the private key received from the authentication server.

In an embodiment, the operations also include establishing a first secure session with the authentication server, wherein the private key is received from the authentication server via the first secure session.

In an embodiment, the establishing the first secure session with the authentication server comprises exchanging one or more credentials with the authentication server.

In an embodiment, the private key is received from another computing device communicably coupled to the authentication server.

In an embodiment, the operations also include, responsive to ending the first secure session with the authentication server and ending the second secure session with the remote server, deleting the private key.

In an embodiment, the operations also include responsive to ending the first secure session with the authentication server and ending the second secure session with the remote server, storing the private key.

In an embodiment, the operations also include establishing an X-server on the remote server.

In an embodiment, the operations also include establishing a Remote Desktop Server (RDS) on the remote server.

In an embodiment, the operations also include opening a browser or a native Remote Desktop Client (RDC) that connects to the RDS through the second secure session.

In an embodiment, the second secure session is facilitated via a ssh tunnel.

In an embodiment, a method for establishing a secure connection to remote server without exchanging credentials is provided. The method includes authenticating the computing device with an authentication server and receiving, via the authentication server, a private key. The methods also include establishing a second secure session with a remote server, wherein the second secure session is established based on a public key at the remote server, and the private key received from the authentication server.

In an embodiment, the method also includes establishing a first secure session with the authentication server, wherein the private key is received from the authentication server via the first secure session.

In an embodiment, the establishing the first secure session with the authentication server comprises exchanging one or more credentials with the authentication server.

In an embodiment, the private key is received from another computing device communicably coupled to the authentication server.

In an embodiment, the method also includes responsive to ending the first secure session with the authentication server and ending the second secure session with the remote server, deleting the private key.

In an embodiment, the method also includes responsive to ending the first secure session with the authentication server and ending the second secure session with the remote server, storing the private key.

In an embodiment, the method also includes establishing an X-server on the remote server.

In an embodiment, the method also includes establishing a RDS on the remote server.

In an embodiment, the method also includes opening a browser or a native RDC that connects to the RDS through the second secure session.

In an embodiment, a non-transitory computer-readable medium is provided that comprises instructions, that when executed by a processor, perform operations. The operations include authenticating the computing device with an authentication server and receiving, via the authentication server, a private key. The operations also include establishing a second secure session with a remote server, wherein the second secure session is established based on a public key at the remote server, and the private key received from the authentication server.

Some of the advantages provided by the techniques described herein include avoiding exchanging credentials over untrusted networks between the computing device and the remote server. In this way, a user can access a remote resource securely (e.g., remote desktop server) over an untrusted network connection (e.g., public internet connection) without exchanging login credentials over the public network, which improves security for the user. Additionally, this approach is flexible as it is compatible with existing corporate authentication methods, and the user only needs to authenticate a single time in order to connect to myriad different remote computing resources.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic block diagram of a remote computing system that can implement password-less authentication according to embodiments described herein.

FIG. 2 is another schematic block diagram of the remote computing system with a separate key server that can implement password-less authentication according to embodiments described herein.

FIG. 3 is a schematic block diagram of a remote computing system that can implement password-less authentication with a remote server that can implement one or more Remote Desktop Servers (RDSs) or X servers according to embodiments described herein.

FIG. 4 is a message sequence chart of a method for implementing password-less authentication with a remote server according to embodiments described herein.

FIG. 5 is a block diagram of a computing device 500 suitable for implementing the computing device 102 according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Various embodiments for implementing a remote computing system with password-less authentication are provided. A computing device such as a laptop or other client device can establish a secure connection with a remote server via an untrusted network without exchanging credentials. The computing device can begin by establishing an initial secure session with an authentication server (e.g., a corporate authentication server) and once authenticated by the authentication server, the authentication server can transfer a cryptographic key (e.g., a private key) to the computing device. Using the cryptographic key, the computing device can establish a secure session with the remote server, which already has another cryptographic key (e.g., a public key) installed thereon. In an embodiment, the flow of the method can be as follows:
1. User logs into client HW (e.g., laptop) using a local authentication method (e.g. operating system login). This is optional.
2. Client HW establishes a secure network connection to an authentication server (e.g., secure shell (ssh) tunnel) over an untrusted network.
3. User authenticates on the authentication server.
4. Client HW mounts crypto (private key only) from the authentication server (or a resource connected to the authentication server).
5. Client HW establishes another secure network connection (different from the initial secure network connection established between client HW and the authentication server) to the remote resource using the mounted crypto key over the untrusted network

In an embodiment, the mapped crypto key on client HW gets deleted when client HW gets disconnected from the authentication server and the user loses access to the remote resource. This embodiment can improve security.

In another embodiment, the mapped crypto key on client HW is not deleted and the user can continue using the remote resource, which provides for improved flexibility and reduces resource consumption on the authentication server.

Some of the potential embodiments disclosed herein include:
Access to remote desktops on a public cloud that need to be controlled by a corporate authentication server living on a network separate from the cloud resource
Access to confidential data of one party that have been placed within a network of another party for collaborative tasks. This allows for collaborations between parties in which some confidential data needed for specific tasks must be accessible by one party but not to the other party.
Access of same remote desktops on public cloud from different parties with each party using its own authentication methods. This reduces complexity of collaborations between multiple parties that require access to the same remote resources

The result is that a user can access a remote resource securely (i.e. remote desktop server) over an untrusted network connection (i.e. public internet connection) without exchanging login credentials over the public network. Some of the benefits and advantages provided includes:
Security: No credentials are passed through the (potentially public) network connection between user's client and Remote Desktop Server.
Flexibility: This approach is compatible with any corporate authentication method (requirement: cryptographic keys are mounted after authentication of client's hardware).
Convenience: User needs to authenticate only once.

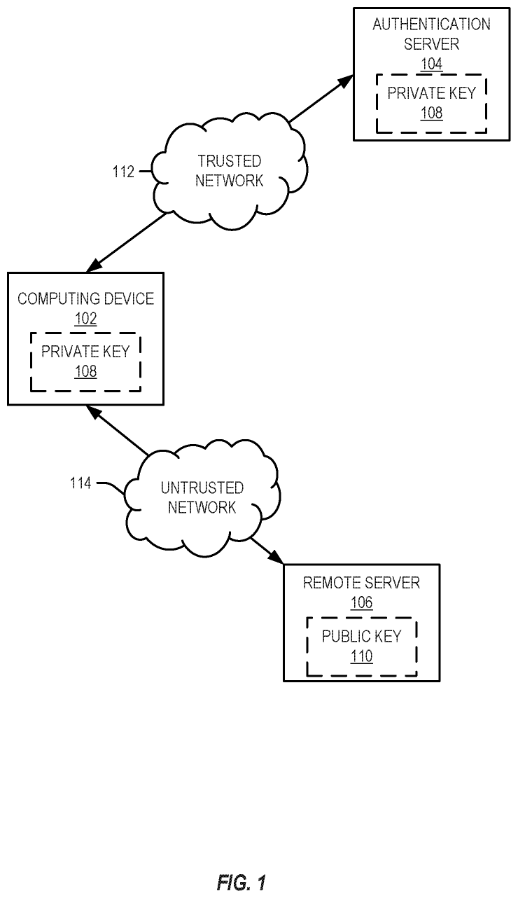

FIG. 1 is a schematic block diagram of a remote computing system that can implement password-less authentication according to embodiments described herein.

On a computing device 102 (e.g., a client device, laptop, desktop, wireless device, User Equipment, or other user device) operated by a user, the user authenticates themselves onto the computing device 102 through Windows Hello or Azure AD via the authentication server 104 in a trusted network 112. The authentication server 104 could be a corporate authentication server and the trusted network 112 could for example be part of a corporate network. To authenticate with the authentication server 104 and initiate a first secure session with the authentication server 104, the user enters one or more credentials at the computing device 102 which get exchanged with the authentication server 104. The first secure session (e.g., via a ssh (secure shell) tunnel) is established with the authentication server and once established, a private key 108 that is generated and/or stored at the authentication server 104 gets mapped and/or mounted to the computing device 102.

Using the private key 108 that is mounted to the computing device 102, the computing device can establish a second secure session (e.g., another ssh tunnel) with the remote server 106 via an untrusted network 114. The second secure session is established using the private key 108 and a public key 110 that is already placed at the remote server 106. The public key 110 could have been placed at the remote server 106 previously via a secure connection between the authentication server 104 and the remote server 106. The public key 110 installed at the remote server 106 could have been installed during a previous session, could have been installed at configuration, or could have been installed at any time via a remote computing session, or even by copying from physical media (e.g., thumb drive, flash drive, etc.).

The steps performed by the computing device 102 could have been initiated and/or executed via a script executed at the computing device 102 to automate the second secure session with the remote server 106.

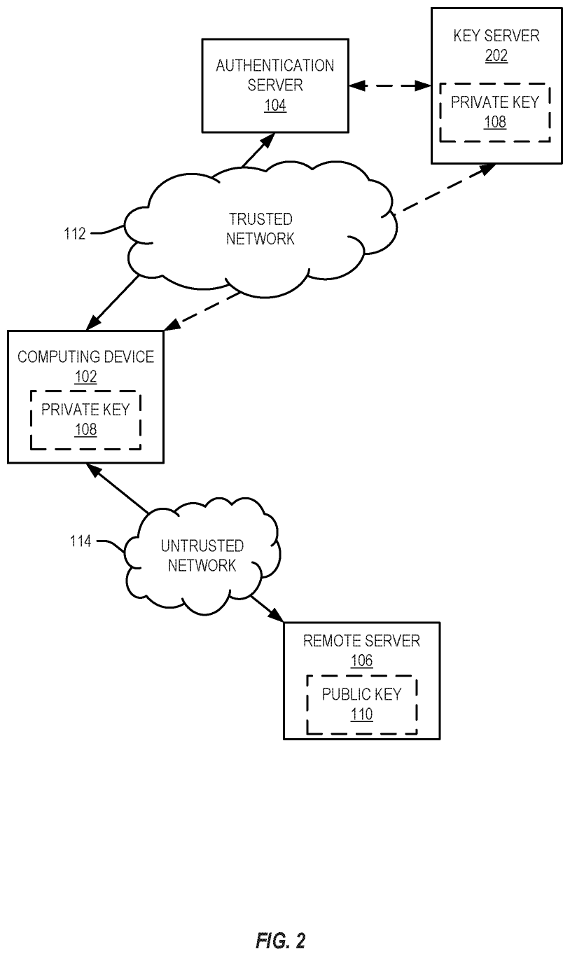

FIG. 2 is another schematic block diagram of the remote computing system with a separate key server that can implement password-less authentication according to embodiments described herein.

The embodiment in FIG. 2 is similar to the embodiment in FIG. 1, except that the private key 108 that is provided to the computing device 102 can originate not at the authentication server 104, but at a separate resource such as key server 202. Key server 202 could be any repository that stores private keys for different computing devices. The key server 202 can belong to the same network (e.g., trusted network 112) as the authentication server 104. When the computing device 102 is authenticated by the authentication server 104, the key server 202 can provide the private key 108 directly to the computing device 102 via the trusted network 112, or the key server 202 can provide the private key 108 to the authentication server 104 to deliver to the computing device 102 via the first secure session.

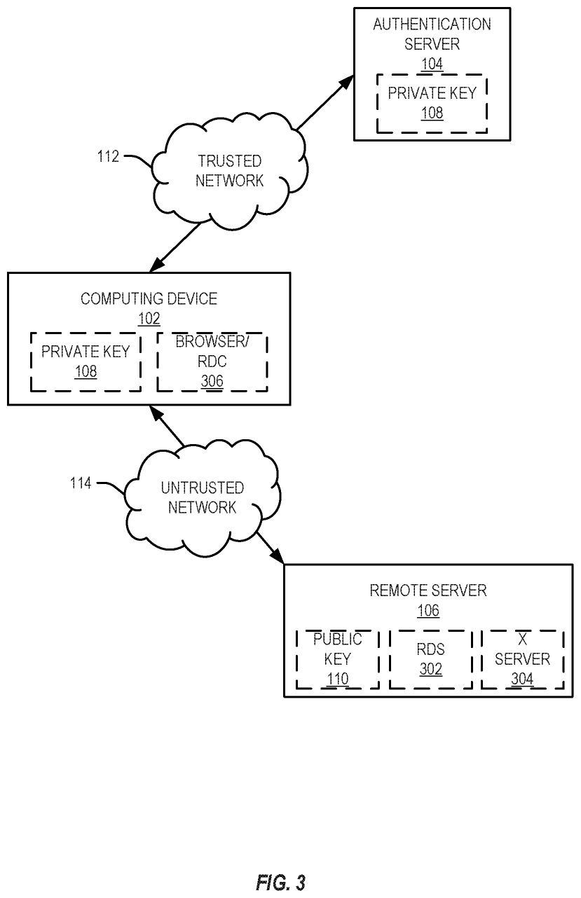

FIG. 3 is a schematic block diagram of a remote computing system that can implement password-less authentication with a remote server that can implement one or more Remote Desktop Servers (RDSs) or X servers according to embodiments described herein.

The embodiment in FIG. 3 is similar to the embodiment in FIG. 1 except that after the second secure session is established between the remote server 106 and the computing device 102 via the untrusted network 114, a script on the computing device 102 can be initiated which enables a browser on the computing device to connect to a browsing server on the remote server 106.

In an embodiment, the script starts an X server 304 and an RDS (i.e. Penguin Solution's Scyld Cloud Workstation server) 302 on the remote server 106. A browser and/or a Remote Desktop Client (RDC) (i.e. Penguin Solution's Scyld Cloud Workstation client) 306 on the computing device 102 can also be opened which connects to the RDS server 302 through the ssh tunnel of the second secure session. It is to be appreciated that while this embodiment describes an X server 304 and a RDS server 302 on the remote server 106, the remote server 106 can have other servers and applications that enable the computing device 102 to interact with the remote server 106 as a remote desktop server or access resources on the remote server 106 in other manners.

In an embodiment, RDS is software that runs on a computer and serves the desktop of this computer to a remote computer with which the user interacts. This allows the user to control a computer remotely. The RDC is software that runs on a computer which allows a user to connect to a remote computer and control/interact with such remote computer which runs a remote desktop server. Some RDS software allow a browser to control/interact with a remote computer which runs such RDS software.

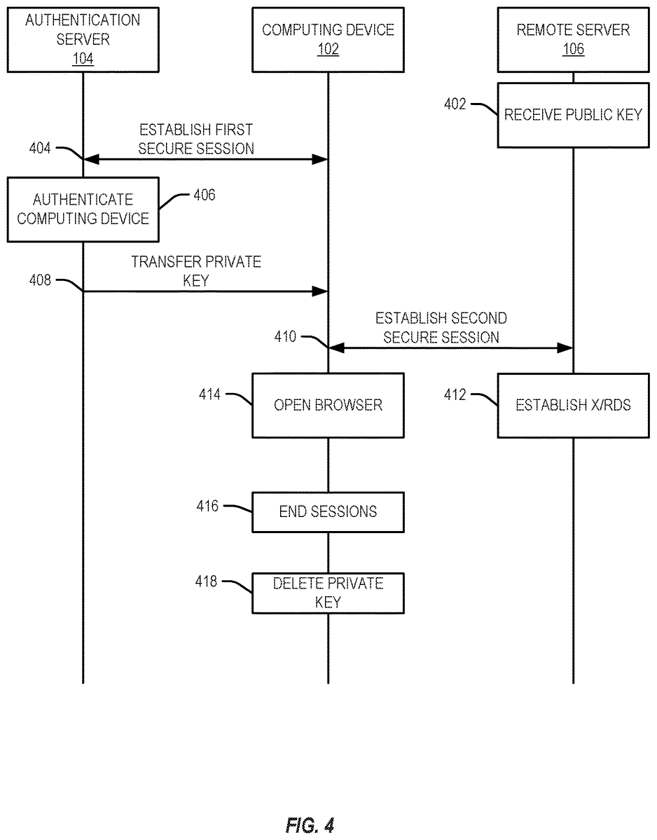

FIG. 4 is a message sequence chart of a method for implementing password-less authentication with a remote server according to embodiments described herein.

The method of FIG. 4 can begin at step 402, where the remote server 106 can receive a cryptographic key (e.g., the public key 110). The public key can be received from the authentication server 104 during a previous session, could have been installed at configuration, or could have been installed at any time via a remote computing session, or even by copying from physical media (e.g., thumb drive, flash drive, etc.).

At step 404, the computing device 102 and the authentication server 104 establish the first secure session. This first secure session can be established by the computing device 102 exchanging one or more credentials with the authentication server 104, and then establishing an ssh tunnel between the authentication server 104 and the computing device 102.

Once the computing device is authenticated by the authentication server 104 at step 406, the authentication server 104 at step 408 can transfer a private key to the computing device 102.

With the private key, the computing device 102, at step 410, can establish a second secure session with the remote server 106 along with the public key previously received by the remote server 106. Once the second secure session is established, at step 412 the remote server 106 can initiate the X server and/or RDS server, and then at step 414, the computing device 102 can open a browser and connect to the X server and/or RDS server and access one or more resources at the remote server 106. At step 416, the computing device 102 can end the first secure session and/or the second secure session and optionally, at step 418, the computing device 102, can, responsive to ending the one or more secure sessions, delete the private key from the computing device 102. To access the remote server 106 again, the computing device 102 would have to reconnect to the authentication server 104 and get the private key remapped. This embodiment can improve security.

Alternatively, the computing device 102 does not delete the private key, and the private key is stored at the computing device 102, enabling the computing device 102 to remain connected and or reconnect easily with the remote server 106. This embodiment provides for improved flexibility, security and reduces resource consumption on the authentication server.

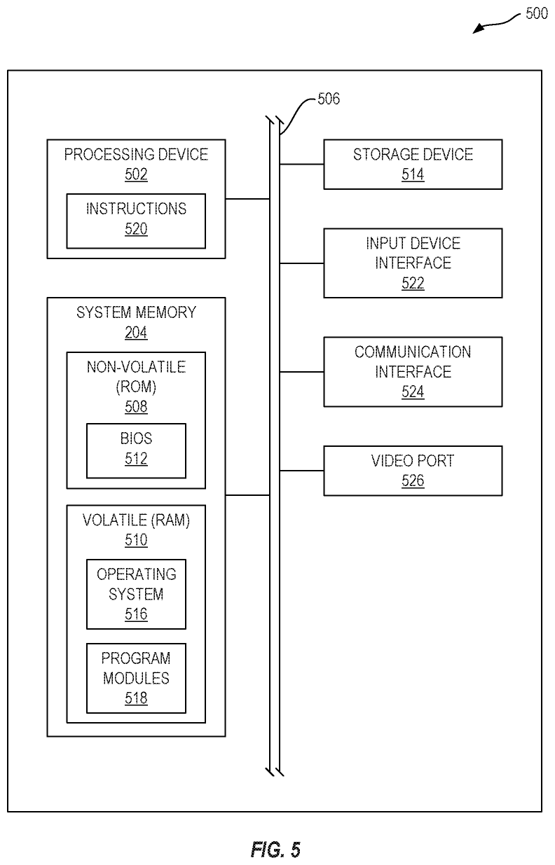

FIG. 5 is a block diagram of a computing device 500 suitable for implementing the password-less authentication according to embodiments disclosed herein. The computing device 500 can implement any one of computing device 102, remote server 106, or authentication server 104 and could be any computing or electronic device capable of including firmware, hardware, and/or executing software instructions that could be used to perform any of the methods or functions described above, such as impostor detection. In this regard, the computing device 500 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computing device 500 in this embodiment includes a processing device 502 or processor, a system memory 504, and a system bus 506. The processing device 502 represents one or more commercially available or proprietary general-purpose processing devices, such as a microprocessor, central processing unit (CPU), or the like. More particularly, the processing device 502 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 502 is configured to execute processing logic instructions for performing the operations and steps discussed herein.

In this regard, the various illustrative logical blocks, modules, and circuits described in connection with the embodiments disclosed herein may be implemented or performed with the processing device 502, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 502 may be a microprocessor, or may be any conventional processor, controller, microcontroller, or state machine. The processing device 502 may also be implemented as a combination of computing devices (e.g., a combination of a DSP and a microprocessor, a plurality of microprocessors, one or more microprocessors in conjunction with a DSP core, or any other such configuration).

The system memory 504 may include non-volatile memory 508 and volatile memory 510. The non-volatile memory 508 may include read-only memory (ROM), erasable programmable read-only memory (EPROM), electrically erasable programmable read-only memory (EEPROM), and the like. The volatile memory 510 generally includes RAM (e.g., dynamic random-access memory (DRAM), such as synchronous DRAM (SDRAM)). A basic input/output system (BIOS) 512 may be stored in the non-volatile memory 508 and can include the basic routines that help to transfer information between elements within the computing device 500.

The system bus 506 provides an interface for system components including, but not limited to, the system memory 504 and the processing device 502. The system bus 506 may be any of several types of bus structures that may further interconnect to a memory bus (with or without a memory controller), a peripheral bus, and/or a local bus using any of a variety of commercially available bus architectures.

The computing device 500 may further include or be coupled to a non-transitory computer-readable storage medium, such as a storage device 514, which may represent an internal or external hard disk drive (HDD), flash memory, or the like. The storage device 514 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 516 and any number of program modules 518 or other applications can be stored in the volatile memory 510, wherein the program modules 518 represent a wide array of computer-executable instructions corresponding to programs, applications, functions, and the like that may implement the functionality described herein in whole or in part, such as through instructions 520 on the processing device 502. The program modules 518 may also reside on the storage mechanism provided by the storage device 514. As such, all or a portion of the functionality described herein may be implemented as a computer program product stored on a transitory or non-transitory computer-usable or computer-readable storage medium, such as the storage device 514, volatile memory 510, non-volatile memory 508, instructions 520, and the like. The computer program product includes complex programming instructions, such as complex computer-readable program code, to cause the processing device 502 to carry out the steps necessary to implement the functions described herein.

An operator, such as the user, may also be able to enter one or more configuration commands to the computing device 500 through a keyboard, a pointing device such as a mouse, or a touch-sensitive surface, such as the display device, via an input device interface 522 or remotely through a web interface, terminal program, or the like via a communication interface 524. The communication interface 524 may be wired or wireless and facilitate communications with any number of devices via a communications network in a direct or indirect fashion. An output device, such as a display device, can be coupled to the system bus 506 and driven by a video port 526. Additional inputs and outputs to the computing device 500 may be provided through the system bus 506 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A computing device, comprising:
a processor; and
computer executable instructions that when executed by the processor cause the computing device to perform operations, comprising:
authenticating the computing device with an authentication server;
receiving, via the authentication server, a private key; and
establishing a second secure session with a remote server, wherein the second secure session is established based on a public key at the remote server, and the private key received from the authentication server.

2. The computing device of claim 1, wherein the operations further comprise:
establishing a first secure session with the authentication server, wherein the private key is received from the authentication server via the first secure session.

3. The computing device of claim 2, wherein the establishing the first secure session with the authentication server comprises exchanging one or more credentials with the authentication server.

4. The computing device of claim 1, wherein the private key is received from another computing device communicably coupled to the authentication server.

5. The computing device of claim 2, wherein the operations further comprise:
responsive to ending the first secure session with the authentication server and ending the second secure session with the remote server, deleting the private key.

6. The computing device of claim 2, wherein the operations further comprise:
responsive to ending the first secure session with the authentication server and ending the second secure session with the remote server, storing the private key.

7. The computing device of claim 1, wherein the operations further comprise:
establishing an X-server on the remote server.

8. The computing device of claim 1, wherein the operations further comprise:
establishing a remote desktop server (RDS) on the remote server.

9. The computing device of claim 8, wherein the operations further comprise:
opening a browser or a native remote desktop client (RDC) that connects to the RDS through the second secure session.

10. The computing device of claim 1, wherein the second secure session is facilitated via a ssh tunnel.

11. A method, performed by a computing device, for establishing a secure connection to remote server without exchanging credentials, the method comprising:
authenticating the computing device with an authentication server;
receiving, via the authentication server, a private key; and
establishing a second secure session with a remote server, wherein the second secure session is established based on a public key at the remote server, and the private key received from the authentication server.

12. The method of claim 11, further comprising:
establishing a first secure session with the authentication server, wherein the private key is received from the authentication server via the first secure session.

13. The method of claim 12, wherein the establishing the first secure session with the authentication server comprises exchanging one or more credentials with the authentication server.

14. The method of claim 11, wherein the private key is received from another computing device communicably coupled to the authentication server.

15. The method of claim 12, further comprising:
responsive to ending the first secure session with the authentication server and ending the second secure session with the remote server, deleting the private key.

16. The method of claim 12, further comprising:
responsive to ending the first secure session with the authentication server and ending the second secure session with the remote server, storing the private key.

17. The method of claim 11, further comprising:
establishing an X-server on the remote server.

18. The method of claim 12, further comprising:
establishing a remote desktop server (RDS) on the remote server.

19. The method of claim 18, further comprising:
opening a browser or a native remote desktop client (RDC) that connects to the RDS through the first secure session.

20. A non-transitory computer-readable medium, comprising instructions, that when executed by a processor, perform operations, comprising:
authenticating a computing device with an authentication server;
receiving, via the authentication server, a private key; and
establishing a second secure session with a remote server, wherein the second secure session is established based on a public key at the remote server, and the private key received from the authentication server.
